(19) United States
(12) Patent Application Publication
(10) Pub. No.: US 2026/0277219 A1
(43) Pub. Date: Sep. 17, 2026

(54) INCREASING THRUST OUTPUT BASED ON CONTROL SURFACE LIMITS

(71) Applicant: Toyota Motor Engineering & Manufacturing North America, Inc., Plano, TX (US)

(72) Inventors: Tom M. Neuman, Fairfax, VA (US); Frank K. Kozel, Glen Burnie, MD (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/207,506

(22) Filed: May 14, 2025

Related U.S. Application Data
(60) Provisional application No. 63/770,538, filed on Mar. 12, 2025.

(51) Int. Cl. G05D 1/49

(52) U.S. Cl. CPC G05D 1/49

(57) ABSTRACT

Systems, methods, and other embodiments described herein relate to augmenting the attitude control capability of a thruster-blown control surface. In one embodiment, the method includes receiving an attitude control command for an aircraft that has a thruster-blown control surface. The attitude control command defines a target attitude for the aircraft. The method also includes detecting, responsive to the attitude control command, that a control surface of the aircraft is within a threshold range of a limit of the control surface to set the aircraft to the target attitude. The method also includes increasing a thruster output past the control surface responsive to the control surface being within the threshold range of the limit.

### CROSS-REFERENCE TO RELATED APPLICATIONS

This application claims the benefit of U.S. Provisional Application No. 63/770,538, filed on Mar. 12, 2025, which is herein incorporated by reference in its entirety.

### TECHNICAL FIELD

The subject matter described herein relates, in general, to aircraft with thruster-blown control surfaces and, more particularly, to increasing thrust output past the control surface responsive to an indication that the control surface is approaching a limit of providing a target attitude state for the aircraft.

### BACKGROUND

In aircraft terminology, a control surface refers to a movable component of an aircraft, sometimes found on wings, horizontal stabilizers, and/or vertical stabilizers, that alters the airflow to create aerodynamic forces that move the aircraft through the air. Via manipulation of these control surfaces (e.g., canards, ailerons, elevators, rudders, stabilizers, and others), a pilot, whether on the aircraft or remotely controlling the aircraft from the ground, can steer the aircraft.

In some aircraft, the control surfaces are positioned in the airflow from a thruster of the aircraft. For example, ailerons may be placed on the wing of an aircraft behind a wing-mounted propeller. The propeller generates a higher velocity airflow at a greater pressure, which increases the capability of the control surface to alter the flight path of the aircraft than may be possible with environmental airflow alone. That is, the high-speed thrust output increases the aerodynamic forces through which the control surfaces alter the aircraft's flight path. These thruster-blown control surfaces enable precise aircraft control, even at low airspeeds.

### SUMMARY

In one embodiment, example systems and methods relate to a manner of improving the ability of a control surface to place the aircraft in a target attitude, as defined by an attitude control command received from either an onboard pilot or a remote pilot. In one embodiment, an attitude control system is disclosed. The attitude control system includes a processor and a memory storing machine-readable instructions that, when executed by the processor, cause the processor to receive an attitude control command for an aircraft that has a thruster-blown control surface. The attitude control command defines a target attitude for the aircraft. The memory also stores machine-readable instructions that, when executed by the processor, cause the processor to detect, responsive to the attitude control command, that a control surface of the aircraft is within a threshold range of a limit of the control surface to set the aircraft to the target attitude. The memory also stores machine-readable instructions that, when executed by the processor, cause the processor to increase a thruster output past the control surface responsive to the control surface being within the threshold range of the limit.

In one embodiment, the system includes an aircraft input device, the aircraft input device receives an attitude control command for an aircraft that has a thruster-blown control surface. The attitude control command defines a target attitude for the aircraft. The system also includes a sensor. The sensor detects, responsive to the attitude control command, that a control surface of the aircraft is within a threshold range of a limit of the control surface to set the aircraft to the target attitude. The system also includes a control device. The control device increases a thruster output past the control surface responsive to the control surface being within the threshold range of the limit.

In one embodiment, a method for improving the ability of a control surface to place the aircraft in a target attitude is disclosed. In one embodiment, the method includes receiving an attitude control command for an aircraft that has a thruster-blown control surface. The attitude control command defines a target attitude for the aircraft. The method also includes detecting, responsive to the attitude control command, that a control surface of the aircraft is within a threshold range of a limit of the control surface to achieve the target attitude. The method also includes increasing a thruster output past the control surface responsive to the control surface being within the threshold range of the limit.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of an aircraft within which systems and methods disclosed herein may be implemented.

FIG. 2 illustrates one embodiment of a thruster output control system that is associated with increasing a thruster output past a control surface, according to an embodiment of the principles described herein.

FIG. 3 illustrates one embodiment of a thruster output control system that is associated with increasing a thruster output past a control surface, according to an embodiment of the principles described herein.

FIG. 4 illustrates a flowchart for one embodiment of a method that is associated with increasing a thruster output past a control surface, according to an embodiment of the principles described herein.

FIG. 5 is a cross-sectional view of a wing and control surface with unchanged thruster output past the control surface, according to an embodiment of the principles described herein.

FIG. 6 is a cross-sectional view of a wing and control surface with thruster output increased to achieve a target attitude, according to an embodiment of the principles described herein.

FIG. 7 is a side view of an aircraft indicating a difference between a target attitude and a measured attitude, according to an embodiment of the principles described herein.

FIG. 8 is a side view of an aircraft indicating an aligned target attitude and measured attitude, according to an embodiment of the principles described herein.

FIG. 9 depicts a control loop where thrust output is mapped to a deflection position of a control surface, according to an embodiment of the principles described herein.

FIG. 10 depicts a control loop where thrust output is mapped to a difference between a measured and target attitude for the aircraft, according to an embodiment of the principles described herein.

FIG. 11 depicts a control loop where thrust output is mapped to a time-dependent difference between a measured and target attitude for the aircraft, according to an embodiment of the principles described herein.

FIG. 12 depicts a control loop where thrust output augments a climb rate command, according to an embodiment of the principles described herein.

FIG. 13 depicts a control loop where thrust output is smoothed based on a time-based ramp, according to an embodiment of the principles described herein.

FIG. 14 depicts a control loop that implements a deactivation system, according to an embodiment of the principles described herein.

### DETAILED DESCRIPTION

Systems, methods, and other embodiments associated with improving the effect of control surfaces are disclosed herein. As previously described, aircraft include control surfaces to manipulate the aircraft attitude (i.e., pitch, roll, and yaw) during flight. There are various control surfaces, such as elevators, ailerons, rudders, flaps, spoilers, stabilators, elevons, and canards. Any of these control surfaces may be positioned in the airflow from an aircraft thruster. That is, an aircraft may include a thruster such as a propeller, a jet engine, or a ducted fan. A control surface in the direct airflow path behind these thrusters may exhibit increased control effectiveness. That is, the thruster may increase the velocity and/or pressure of the airflow across the trailing control surface. The increased aerodynamic forces acting on the control surfaces increase the ability of the control surfaces to manipulate the flight path and attitude of the aircraft.

The present specification describes a control system that augments aerodynamic controls. That is, there may be some circumstances when the control surfaces are unable to position the aircraft with a target attitude. This may be due to physical constraints of the control surface or flight conditions. For example, to change the attitude (i.e., pitch, roll, or yaw) of an aircraft, the control surface deflects. However, the control surface may have a limit on its range of motion. For example, a control surface may have a range of motion that is plus or minus 45 degrees from a reference position, which reference position may be horizontal relative to the aircraft longitudinal axis. Accordingly, a pilot may set an attitude for the aircraft, and if the control surfaces are at or near their physical deflection limit, the aircraft may fall short of the pilot-set attitude. While particular reference is made to a particular deflection limit (i.e., ±45°), different control surfaces may have different deflection limits, for example, between ±35-45°, between ±25-35°, between ±15-25°, or other ranges.

As another example, flight conditions may impact the control provided by the control surfaces. For example, environmental conditions such as humidity, air density, and elevation, among other conditions, and aircraft variables such as aircraft speed and weight, among others, may impact air flow across the control surface. As such, the effect of the control surface is defined, at least in part, by these environmental conditions and vehicle parameters.

As yet another example, the angle of attack (defined as the angle between the chord line of the control surface and the direction of oncoming airflow) may impact the flight conditions. That is, control surfaces generate control by directing airflow over and under their surfaces. When the angle of attack becomes too great, air does not follow the contours of the control surface, reducing the effect of the control surface.

The present specification describes a system that augments aerodynamic control in the face of these and other limits. Specifically, the present specification describes a system that adjusts the thrust of the aircraft, or the flow of air over the thruster-blown control surfaces, in the face of the control surface approaching a limit in its ability to set the aircraft to a desired, or target, attitude. That is, in addition to the effect of thrust to accelerate the aircraft and cause the aircraft to climb or descend, the present specification uses the thrust of the aircraft to augment attitude control. That is, the thruster augments the effectiveness of aerodynamic control surfaces if they are at or near their physical deflection limits and/or the control surfaces fail to achieve a desired control output.

In an example, the thrust-altering control signal is used to prevent the loss of attitude control and is not always active. Adding throttle causes the aircraft to climb or accelerate, which may not be desirable in normal circumstances. However, a climb or acceleration may be preferable to losing attitude control. Accordingly, the attitude control system may use the throttle when the control surface is at or near its physical deflection limits and/or the control surfaces fail to achieve the desired control output.

Specifically, the system, which may include electronic or mechanical control devices, determines when the control surface is approaching a limit, either based on the control surface reaching a deflection limit or a measured attitude of the aircraft being different from a target attitude given an attitude control command from a pilot. When either of these conditions is met, the electronic or mechanical control device increases the output of the thruster of the aircraft, which increases the airflow past the thruster-blown control surface. As described above, the increase in airflow increases the control capability of any of the aforementioned control surfaces. As such, the present system increases aerodynamic control of the control surfaces by increasing the output of an aircraft thruster when it is determined that the control surfaces are unable to provide a desired attitude control absent the increased airflow. In an example, the thruster output is ramped up gradually above a certain surface angle or control output level. Doing so prevents sudden throttle change, which could result in jerkiness during aircraft flight.

As described above, the present attitude control system may be implemented in any thruster-blown aircraft, including short takeoff and landing (STOL) aircraft, tilt-wing aircraft, tail-sitter aircraft, and free-wing aircraft (where the wings of the aircraft freely rotate about a pitch axis independent of the fuselage of the aircraft), among others. Also, as described above, the present attitude control system may be implemented in thruster-blown aircraft that rely on different types of thrusters, including propellers, jet engines, and ducted fans, among others. In any case, the attitude control system augments aircraft aerodynamic control by increasing thrust and airflow over the control surface when the control surface is at or near its control limit and does so by mapping control surface parameters to thrust outputs.

As used in the present specification and in the appended claims, the term “attitude control command” refers to a command from a pilot, whether on board, remote, or from an automated flight controller, to change the attitude of the aircraft. As described above, the attitude of the aircraft refers to its pitch, roll, or yaw position during flight. The attitude control command may define a target attitude for the aircraft. The attitude control command may be 1) an attitude value (i.e., measured in degrees) command or 2) an attitude rate (i.e., measured in degrees per second) command, where the command indicates a rate of change of the attitude over time.

As used in the present specification and in the appended claims, the term “target attitude” may refer to a desired pose for the aircraft (i.e., pitch, yaw, and roll) as defined by the attitude control command issued by a pilot, operator, or automated flight controller. For example, an onboard pilot may move a control stick to roll the aircraft to a particular position. The target attitude may refer to an attitude defined by the position of the control stick. As another example, a remote pilot may move a joystick to effectuate a particular pitch in the aircraft. In this example, the target attitude may refer to a pitch angle that is defined by the position of the joystick. While particular reference is made to a single axis position of the aircraft (i.e., a roll position or a pitch position), the target attitude may define one or multiple of a target roll position, pitch position, and yaw position of the aircraft. Moreover, as described above, the target attitude may be based on a rate command instead of an attitude value. For example, a pilot or remote operator may move an input device to carry out a particular maneuver at a particular pitch rate. In this example, the target attitude may be a pitch position of the aircraft to perform the particular maneuver.

Further, as used in the present specification and in the appended claims, the term “limit” refers to a boundary of the control surface capability to set the aircraft to the target attitude. The limit may refer to at least one of a deflection limit or another limit in the ability of the control surface to set the aircraft to the target attitude, which other limit may be defined by environmental conditions, vehicle parameters, and flight conditions as described above.

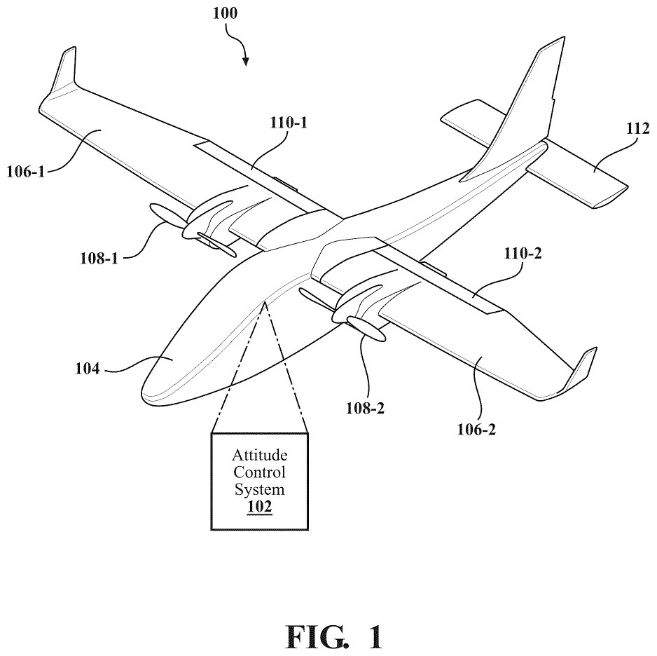

Turning now to the figures, FIG. 1 illustrates one embodiment of an aircraft 100 within which systems and methods disclosed herein may be implemented. It will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, the aircraft 100 includes an attitude control system 102 that is implemented to perform methods and other functions as disclosed herein relating to enhancing the aerodynamic effect of various aircraft control surfaces.

In general, the aircraft 100 includes a fuselage 104, or body, in which mechanical, electrical, and/or control systems are housed. As described above, the aircraft 100 may have a variety of uses, and the flight control components and components specific to the particular use may be housed within the fuselage 104. As a particular example, the aircraft 100 may be unmanned. In this case, the fuselage 104 houses a communication system for receiving and executing commands from a remote operator. In another example, the aircraft 100 is locally operated by a pilot on board the aircraft 100. In this example, the fuselage 104 includes a cockpit where the pilot sits to control the aircraft 100.

The aircraft 100 also includes a pair of wings 106-1 and 106-2 extending away from the fuselage 104. The wings 106-1 and 106-2 in combination may be referred to as a wing assembly. In one specific example, the aircraft 100 is a free-wing aircraft in which the wing assembly (including both wings 106-1 and 106-2) rotates independently about a pitch axis of the fuselage 104 of the aircraft 100. In this example, the wings 106-1 and 106-2 and fuselage 104 are coupled together via bearings or bushings that pivot freely, i.e., with minimal mechanical friction or damping, in pitch. In one example, the wings 106-1 and 106-2 of a free-wing aircraft are rigidly coupled to one another such that the entire wing assembly rotates as a single unit independently of the fuselage 104. In another example, each wing 106-1 and 106-2 is independently rotatable about the pitch axis relative to the other wing and the fuselage 104. In other examples, the aircraft 100 is a fixed-wing aircraft, meaning that the wings 106-1 and 106-2 do not rotate about the pitch axis independently of the fuselage 104.

The aircraft 100 also includes thrusters, which in the example depicted in FIG. 1, are propellers 108-1 and 108-2 mounted to respective wings 106-1 and 106-2. In general, a thruster is any device or engine that generates thrust to move or control the aircraft 100. While FIG. 1 depicts propellers 108-1 and 108-2 as the thrust source, the aircraft 100 may include different kinds of thrust sources, such as jet engines and ducted fans, among others. Additionally, while FIG. 1 depicts two propellers 108-1 and 108-2, any number of thrusters may be installed on the aircraft 100. For example, the aircraft 100 may include one propeller on the front of the fuselage 104, four jet engines across the wings 106-1 and 106-2, and so on.

A thruster generates forward motion in the aircraft by pushing air backwards. In a propeller-powered aircraft, the backward-directed air may be referred to as the propwash or slipstream. In a jet engine or ducted fan-powered aircraft, the backward-directed air may be referred to as jetwash or exhaust.

As described above, the aircraft may include any number of control surfaces. For example, ailerons 110-1 and 110-2 may be formed on respective wings 106-1 and 106-2. As another example, the aircraft 100 may include an elevator 112 on the tail of the aircraft 100. The control surfaces change the airflow around the aircraft 100. Changes in airflow generate aerodynamic forces that move the aircraft 100 during flight. Put another way, the attitude of the aircraft 100, that is, the aircraft pitch, yaw, and roll, may be altered by adjusting the position of different control surfaces.

As described above and as depicted in FIG. 1, some control surfaces, such as ailerons 110-1 and 110-2, may be positioned behind the thruster and thus in the airflow path behind the thruster. Doing so may increase the efficacy of the aircraft attitude adjustment capabilities of the control surfaces compared to their efficacy absent the thruster airflow. That is, the increased airflow generated by the thrusters (e.g., the propellers 108-1 and 108-2) in FIG. 1 provides for greater and/or more responsive alteration of the attitude of the aircraft 100. Note that while FIG. 1 depicts particular control surfaces (i.e., ailerons 110-1 and 110-2 and an elevator 112) in the blown path of the thrusters, other control surfaces (i.e., canards, tail, spoilers, etc.) may similarly be placed behind the thrusters.

As described above, the control surface's ability to set or control the attitude of the aircraft 100 may be limited, for example, by deflection limits of the control surfaces and/or flight conditions. Accordingly, the aircraft 100 may include an attitude control system 102 to increase the output of the thrusters when it is determined that the control surfaces are at their limit, whether the limit is a control surface deflection limit or a limit in the control surface's ability to set the aircraft 100 to a target attitude. As such, the inputs to the attitude control system 102 may be 1) a target attitude, which may be defined by an attitude control command received from an onboard or remote pilot, and 2) either an actual pitch state of the aircraft 100 or a deflection position of the control surface.

Responsive to the control surface being at or near at least one of the aforementioned limits, the attitude control system 102 may increase the output of the thruster, which increases the airflow over the control surface. To increase the thruster output, the attitude control system 102 may transmit a signal to the thruster power source to increase the output.

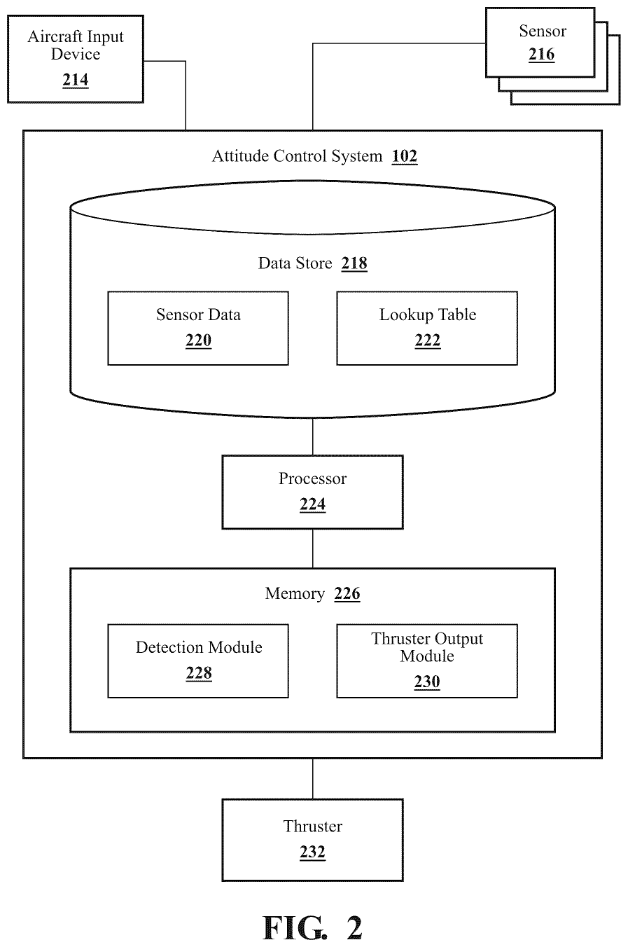

FIG. 2 illustrates one embodiment of an attitude control system 102 that is associated with increasing a thruster 232 output past a control surface, according to an embodiment of the principles described herein. As depicted in FIG. 2, the attitude control system 102 may include a processor 224. In one or more arrangements, the processor(s) 224 can be a primary/centralized processor of the aircraft 100 or may be representative of many distributed processing units. For instance, the processor(s) 224 can be an electronic control unit (ECU). Alternatively, or additionally, the processors include a central processing unit (CPU), an application-specific integrated circuit (ASIC), a microcontroller, a system on a chip (SoC), and/or other electronic processing units that support operation of the aircraft 100.

In one embodiment, the attitude control system 102 includes a memory 226 that stores a detection module 228 and a thruster output module 230. The memory 226 may be a random-access memory (RAM), read-only memory (ROM), a hard-disk drive, a flash memory, or another suitable memory for storing the modules 228 and 230. The modules 228 and 230 may be, for example, machine-readable instructions that, when executed by the processor 224, cause the processor 224 to perform the various functions disclosed herein. In alternative arrangements, the modules 228 and 230 are independent elements from the memory 226 that are, for example, comprised of hardware elements. Thus, the modules 228 and 230 are alternatively ASICs, hardware-based controllers, a composition of logic gates, or another hardware-based solution.

The aircraft 100 may include one or more data stores 218 for storing one or more types of data. In general, the data store 218 is, in one embodiment, an electronic data structure stored in the memory 226 or another data storage device and that is configured with routines that can be executed by the processor 224 for analyzing stored data, providing stored data, organizing stored data, and so on. Thus, in one embodiment, the data store 218 stores data used by the modules 228 and 230 in executing various functions. The data store 218 can be comprised of volatile and/or non-volatile memory. Examples of memory that may form the data store 218 include RAM, flash memory, ROM, PROM (Programmable Read-Only Memory), EPROM (Erasable Programmable Read-Only Memory), EEPROM (Electrically Erasable Programmable Read-Only Memory), registers, magnetic disks, optical disks, hard drives, solid-state drivers (SSDs), and/or other non-transitory electronic storage medium. In one configuration, the data store 218 is a component of the processor(s) 224. In general, the data store 218 is operatively connected to the processor(s) 224 for use thereby. The term “operatively connected,” as used throughout this description, can include direct or indirect connections, including connections without direct physical contact.

In one embodiment, the data store 218 stores the sensor data 220 relied on by the modules 228 and 230. That is, the amount of thruster output adjustment may be based on flight conditions. Accordingly, the sensor data 220 may include data indicative of the flight conditions.

In one example, the thruster output increase is triggered when the control surface is within a threshold range of a deflection limit for the control surface. In this example, the aircraft 100 includes sensors 216 which measure the deflection of the various control surfaces. Accordingly, in this example, the sensor data 220 may include data from sensors 216 that measure the deflection of the control surfaces. Examples of control surface deflection-measuring sensors include a rotary variable differential transformer (RVDT) that measures a rotational displacement, a linear variable differential transformer (LVDT) that measures linear displacement, a potentiometer, an optical or magnetic encoder to track the position of the control surface, and/or a strain gauge, among other deflection sensors.

As described above, the thruster output increase is triggered when the control surface cannot set the aircraft 100 to a target attitude. This may be determined by comparing the target attitude with a measured attitude of the aircraft 100, the difference indicating the inability of the control surface to achieve the target attitude. In this example, the aircraft 100 may include sensors 216 that measure the attitude of the aircraft 100. The output of a pitch sensor, a yaw sensor, and a roll sensor may be included in the sensor data 220. Examples of attitude sensors include an attitude indicator (e.g., an artificial horizon), a gyroscope, a heading indicator (e.g., a compass), an accelerometer, and/or an inertial measurement unit (IMU), among other attitude sensors.

In an example, the thruster output increase may be triggered when the control surface is in an aerodynamic stall state. In this example, the aircraft 100 may include an angle of attack sensor to determine when the angle of attack of a wing is such that an aerodynamic stall is imminent. In this example, the output of the angle of attack sensor may be included in the sensor data 220.

Note that while particular reference is made to particular sensors 216 and particular sensor data 220, the aircraft may include different sensors 216, and the data store 218 may store other sensor data 220, usable by the modules 228 and 230 to alter thruster output based on the control surface reaching a limit.

The data store 218 may store the sensor data 220 along with, for example, metadata that characterizes various aspects of the sensor data 220. For example, the metadata can include location coordinates (e.g., longitude and latitude), relative map coordinates or tile identifiers, time/date stamps from when the separate sensor data 220 was generated, and so on.

In one embodiment, the data store 218 further includes a lookup table 222. In general, the lookup table 222 identifies how the thruster output is to be adjusted given different flight conditions, which flight conditions may be indicative that the control surface is approaching a control limit. In other words, the lookup table 222 maps a thrust output increase to various sensor data 220 conditions.

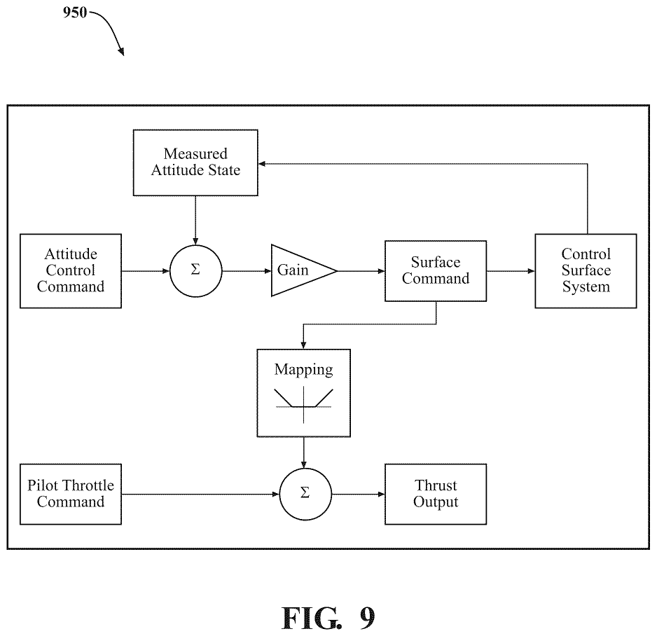

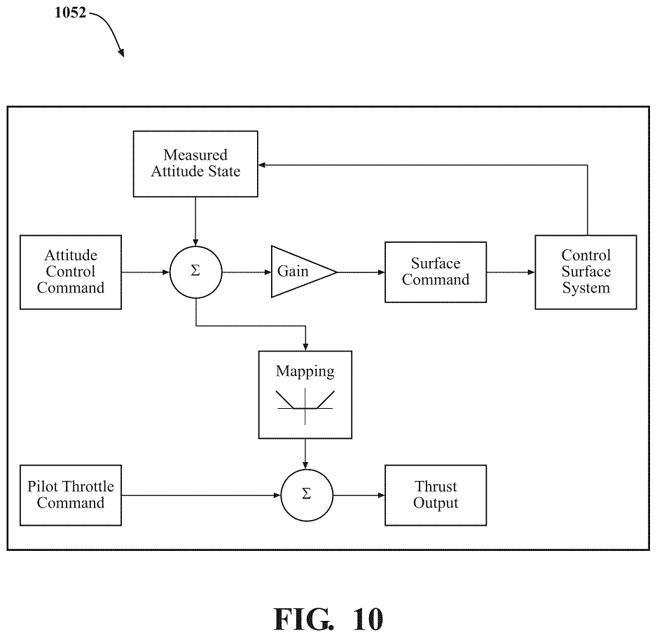

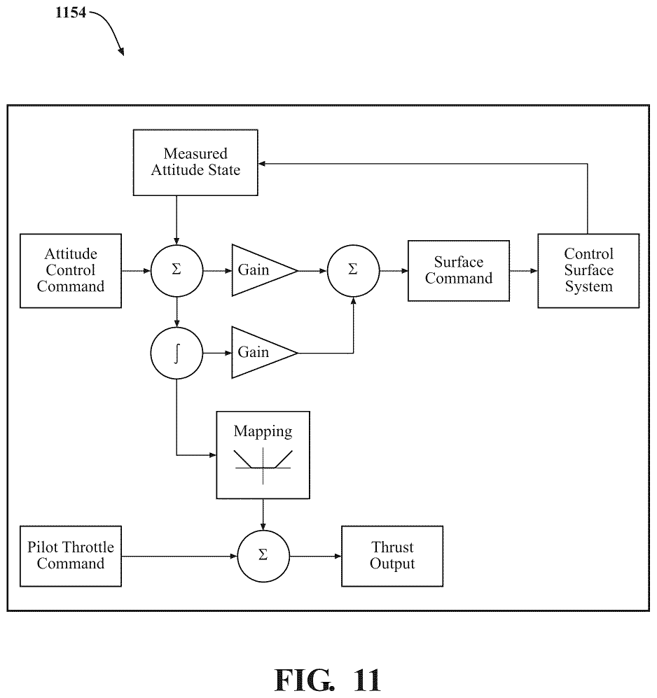

Specifically, the lookup table 222 may map thrust output increase to at least one of 1) a deflection of the control surface (as depicted in FIG. 9), 2) a difference between a target attitude in the attitude control command and the measured attitude of the aircraft 100 (as depicted in FIGS. 10), 3) a time-dependent difference between the target attitude and the measured attitude of the aircraft 100 (as depicted in FIG. 11), or 4) a time-dependence on a previous thrust output increase. Accordingly, the lookup table 222 may identify a thrust output increase, or a thrust output value for each of multiple values of a deflection of the control surface, a detected difference, and/or a time-dependent detected difference. In an example, the thrust output increase may indicate an increase in the rotational speed of the thruster, or an amount of additional power to be output from the engine. In this example, the thruster output module 230 may rely on this mapping, and the output of the detection module 228, when controlling the aircraft 100 thruster to augment the control surface aerodynamic effect. In an example, the mapping may account for a “ramping up” of the thrust output. That is, the amount of thrust increase may be incrementally increased as 1) the control surface approaches the deflection limit or 2) the detected difference between a target attitude and the measured attitude increases. Doing so results in a smooth increase in thrust output for a smoother ride/flight of the aircraft 100.

As described previously, the aircraft 100 can include one or more modules 228 and 230, at least some of which are described herein. In at least one arrangement, the modules 228 and 230 are implemented as non-transitory machine-readable instructions that, when executed by the processor 224, implement one or more of the various functions described herein. In various arrangements, one or more of the modules 228 and 230 are a component of the processor(s) 224, or one or more of the modules 228 and 230 are executed on and/or distributed among other processing systems to which the processor(s) 224 is operatively connected. Alternatively, or in addition, the one or more modules 228 and 230 are implemented, at least partially, within hardware. For example, the one or more modules 228 and 230 may be comprised of a combination of logic gates (e.g., metal-oxide-semiconductor field-effect transistors (MOSFETs)) arranged to achieve the described functions, an ASIC, a programmable logic array (PLA), a field-programmable gate array (FPGA), and/or another electronic hardware-based implementation to implement the described functions. Further, in one or more arrangements, one or more of the modules 228 and 230 can be distributed among a plurality of the modules 228 and 230 described herein. In one or more arrangements, two or more of the modules 228 and 230 described herein can be combined into a single module.

The attitude control system 102 includes a detection module 228, which includes instructions that cause the processor 224 to detect, responsive to an attitude control command, that a control surface of the aircraft 100 is within a threshold range of a limit of the control surface to set the aircraft to the target attitude. That is, to effect a particular attitude within the aircraft 100, a pilot may input a command into an aircraft input device 214. The aircraft input device 214 may take many forms. For example, in a piloted aircraft 100, the aircraft input device 214 may be a control stick, a control yoke, rudder pedals, dial, or other aircraft input device 214. In the example of a remote pilot, the aircraft input device 214 may be a joystick, button, dial on a remote controller, or an input from an aircraft flight computer terminal.

In any case, the attitude control command for the aircraft 100 with a thruster-blown control surface may dictate a particular target attitude for the aircraft 100. For example, the pilot may desire to execute a climb maneuver. In this example, an onboard pilot may pull back on a control yoke, or a remote pilot may move a joystick in a direction toward the remote pilot. In either case, this command from the pilot may include an attitude component that deflects the control surfaces to place the aircraft 100 at a pitch state commensurate with the climb command. For example, a control yoke or joystick remote action as described above may trigger movement of an elevator to an upward position to pitch the aircraft 100 to a specific position to execute the climb maneuver. The control surface controller may deflect the control surface based on the magnitude of the command. For example, for a steeper climb, the elevator may be deflected to a greater degree than a more gradual climb, in which greater deflection translates to a steeper pitch angle of aircraft 100. The target pitch state achieved based on a particular control input, i.e., the attitude control command, may be specific to the aircraft 100 and may be defined by various aircraft parameters such as aircraft weight, aircraft dimensions, thruster type, and thruster size, etc. These are examples of an open-loop target pitch attitude determination.

In another example, the aircraft input device 214 (e.g., the control stick) may be digitally mapped to a desired attitude. In this example, a closed-loop attitude control system moves the elevator 112 or other control surface.

As yet another example, an onboard autopilot or flight computer may control a higher-level state (e.g., a desired climb). A desired attitude defined by characteristics of the desired climb is fed into the attitude control system to alter the deflection of the control surfaces.

As described above, the attitude control command may be an attitude value (e.g., measured in degrees) or an attitude rate (e.g., measured in degrees per unit time). For example, a pilot may dictate a particular roll angle. In another example, the pilot may dictate a change to the roll angle over time. In either case, the target attitude angle or target attitude rate associated with the maneuver command received by the pilot may trigger a change to the control surface deflection.

Whatever the form of the attitude control command, the detection module 228 determines when the control surface is within a control limit, which may refer to a limit of the control surface to set the aircraft 100 in the target attitude. That is, a control surface may be limited in its ability to set the aircraft 100 to a particular target attitude. For example, to carry out a particular maneuver, such as a banked turn, the ailerons 110-1 and 110-2 may be deflected in opposite directions (i.e., for a left turn, the left aileron 110-2 deflects upward and the right aileron 110-1 deflects downward). However, as described above, the control surfaces (e.g., ailerons 110-1 and 110-2) may have limits on the degree to which they can deflect. For example, ailerons may have deflection limits of between ±40-45°, ±30-40°, ±20-30°, ±10-20°, or any other deflection limit range. Once a control surface reaches its deflection limit, it may be unable to effect a more drastic maneuver. That is, in some cases, the control surface may not be able to deflect more to set the aircraft 100 to a target attitude as defined by the attitude control command. Accordingly, in this example, the detection module 228 may include instructions that cause the processor 224 to detect that the control surface is within a threshold range of its deflection limit.

In an example, the deflection limit may be defined within a table stored in the data store 218. That is, the data store 218, specifically the lookup table 222, may include entries that indicate the deflection limit for various thruster-blown control surfaces of the aircraft 100. In another example, the control surface being within a threshold range of the deflection limit may be determined based on the output of a control surface deflection sensor. That is, as described above, the aircraft 100 may include sensors that determine the deflection position of the various control surfaces. Accordingly, when the sensor indicates that the control surface is not deflecting to a greater degree, the detection module 228 may determine that the control surface has reached its deflection limit.

Note that in some examples, the detection module 228 may determine when the control surface is within a threshold range of the deflection limit. That is, it may be desirable to initiate aerodynamic force-augmenting thrust increases before reaching the deflection limit (i.e., before the control surface can no longer provide the target attitude control). Accordingly, the detection module 228 may identify, using any of the methods described above or others, when the control surface is within a threshold range of its deflection limit, and trigger operation of the thruster output increase as indicated. In an example, the threshold range may be any value, for example, 20% below the deflection limit, or 15%, 10%, 5%, or any other value.

In another example, the limit may be defined by the control surface's inability to achieve the target attitude even when the control surface is not at nor is approaching the deflection limit. For example, for a variety of reasons, including environmental conditions (e.g., humidity or air density), aircraft parameters (e.g., vehicle speed or vehicle weight), and/or flight conditions (e. g, angle of attack), a control surface may not be able to effectuate the target attitude. This insufficiency of the control surface may be detected based on a difference between the target attitude, as defined by the attitude control command, and the measured attitude of the aircraft 100. Accordingly, in this example, the detection module 228 includes instructions that cause the processor 224 to 1) detect a difference between the target attitude for the aircraft 100 and a measured attitude of the aircraft 100, and 2) determine that the difference exceeds a predetermined amount.

Accordingly, in this example, the detection module 228 may extract sensor data 220 indicative of the measured attitude of the aircraft 100. The detection module 228 may also calculate, or otherwise determine, the target attitude based on the attitude control command received from the aircraft input device 214. For example, a control yoke or joystick movement may define a particular attitude for the aircraft 100 to carry out a maneuver defined by the control yoke or joystick movement. That is, the target attitude may be defined by the amount of control input and how long the control input is held. However, it may be the case that the measured attitude is different from the target attitude defined by the pilot input. Once the difference between the target attitude and the measured attitude is greater than a predetermined amount, the detection module 228 may output a signal to the thruster output module 230 to generate a thrust increase. Note that the predetermined amount may be various values. For example, the predetermined amount may be a 1% difference between the target attitude and the measured attitude, a 2% difference, a 5% difference, a 10% difference, or a 15% difference, among others.

In another example, the detection module 228 may detect that the control surface is in an aerodynamic stall state. As described above, when the angle of attack of the wings 106-1 and 106-2 is greater than a predetermined amount, the amount of lift generated by the wings 106-1 and 106-2 decreases, as does the effectiveness of the control surfaces. Accordingly, to maintain the control capability of the control surface, it may be desirable to increase the thrust and air flow over the control surface. Accordingly, in this example, the detection module 228 may determine when the sensor data 220 from an angle of attack sensor is greater than a predetermined amount, which predetermined amount may be defined based on various conditions and may be stored in the memory of the detection module 228.

In either case, the output of the detection module 228 is transmitted to the thruster output module 230 which includes instructions that cause the processor 224 to increase a thruster 232 output past the control surface responsive to the control surface being within the threshold range of the limit of the control surface to place the aircraft at the target attitude. That is, the thruster output module 230, in general, transmits signals to the thruster to increase or decrease output based on the output of a detection module 228. This may include transmitting a signal to increase the rotational speed of the thruster, and/or increase the output of the motor of the thruster. In either case, the thruster output module 230 is operatively connected to the detection module 228 and the thruster 232.

In an example, the thruster output module 230 also relies on the lookup table 222 to determine how much to increase the thruster 232 output. That is, the detection module 228 may provide a binary indication that the control surface is within a threshold range of its limit or a numeric indication that the control surface is within a threshold range of its limit (e.g., the deflection angle of the control surface and/or the difference between the target attitude and the measured attitude). Responsive to such, the thruster output module 230 may, relying on the lookup table 222, identify how much to adjust the thruster 232 output. As described above, the thruster 232 may be any of a variety of types, including propellers 108-1 and 108-2, jet engines, ducted fans, or any other type of aircraft thruster. Specifically, the thruster output module 230 may generate an electrical signal with a magnitude that matches the thrust output increase indicated in the lookup table 222 or may instruct a controller of the thruster 232 to increase the thruster 232 output by an amount indicated in the lookup table 222.

In an example, the thruster output module 230 includes instructions that cause the processor 224 to increase the thruster 232 output based on the proximity of the control surface to the limit. Specifically, a closer proximity of the control surface to the limit may trigger a greater increase in the thruster 232 output. This may result in a “ramping up” of the thrust to promote a smooth and comfortable flight. In another example, the thruster output module 230 includes instructions that cause the processor 224 to increase the thruster 232 output based on the difference between the target attitude and the measured attitude, with a greater difference triggering a greater increase in the thruster 232 output.

Put another way, the thruster output module 230 may incrementally increase the thruster 232 output as the control surface approaches the limit. This may smooth out the thrust controls. There may be various ways of implementing the incremental increase, including linear ramps, non-linear ramps, low-pass filters, infinite impulse response (IIR) filters, Kálmán filters, integrators, delays, hysteresis, etc. In another example, the thrust output may not be smoothed. For example, the thruster output module 230 may activate a limit switch when the control surface is within the threshold range of the limit, which limit switch activates a set thrust output increase.

In an example, the thruster output module 230 may include instructions that cause the processor 224 to increase the thruster 232 output to augment at least one of a thrust command, a climb rate command, a speed command, or a total energy state command. That is, during flight, a pilot may issue a command to increase thrust or to initiate a climb of the aircraft 100. Either of these commands triggers an increased output of the thruster 232. The output of the thruster output module 230 may increase the amount of thruster 232 output in addition to that requested by the pilot via a thrust or climb rate command.

A total energy state command combines a speed command and a climb command. For example, increasing pitch can cause a climb. However, speed may drop such that the total energy state of the aircraft 100 is unchanged. Accordingly, both an increase in throttle and power may be triggered to change the energy state (in this case, height). By comparison, increasing the throttle may accelerate the aircraft, which could result in climbing unless the pitch is decreased. Accordingly, a total energy controller and a total energy command manage the attitude and throttle together to direct the energy in a desired direction.

In an example, the throttle command may be an open-loop command, where the pilot directly indicates the power to be added. By comparison, the climb rate command may be a closed-loop command where the pilot, rather than indicating a power increase of the thruster 232, indicates a climb rate. In this case, a thrust controller, not the pilot, determines the thrust increase. As such, the attitude control system 102 may be implemented in open-loop or closed-loop thrust control environments. That is, the thrust output may be augmented on top of a pilot-provided thrust command or a system-provided thrust command (for example, in a climb rate command where the pilot, although providing a command, does not provide a thrust-level command).

As such, the attitude control system 102 operates to maintain or increase the efficacy of a control surface in conditions where the efficacy may otherwise decrease (i.e., in situations where the control surface approaches a deflection limit or cannot provide a target attitude for the aircraft 100).

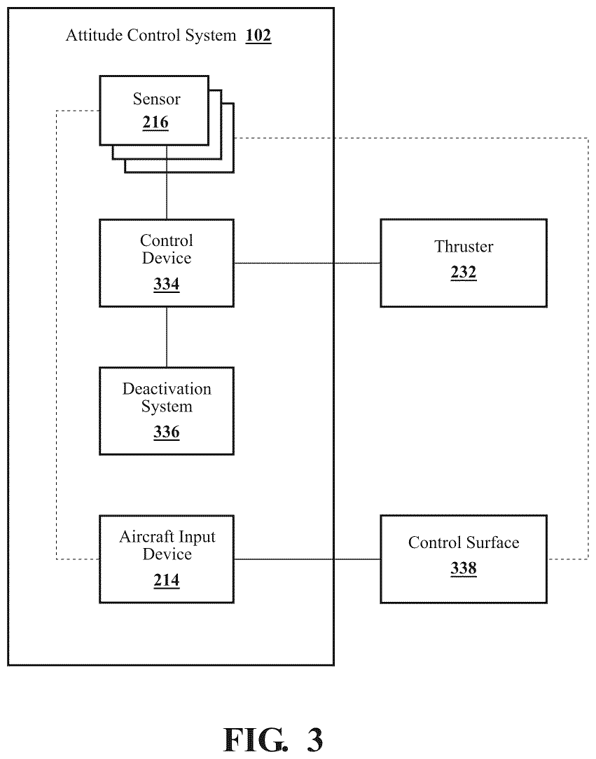

FIG. 3 illustrates one embodiment of an attitude control system 102 that is associated with increasing a thruster output past a control surface 338, according to an embodiment of the principles described herein.

In this example, the system includes an aircraft input device 214, such as that described above, through which an attitude control command for the aircraft 100 is received. That is, the aircraft 100 may include an aircraft input device 214, such as a control yoke, control stick, dial, button, remote control joystick, or others mentioned above, that controls the control surfaces 338 of the aircraft 100 through mechanical, electrical, or electromechanical control systems. In this example, the system also includes a sensor 216, or multiple sensors 216, that detect, responsive to the attitude control command, that a control surface 338 of the aircraft 100 is within a threshold range of a limit of the control surface to set the aircraft 100 to a target attitude defined by the attitude control command. For example, as described above, a control surface deflection sensor may determine that the control surface 338 has reached a deflection limit, or is within a threshold range of a deflection limit, while a pilot is executing a maneuver. The sensor 216 may also be operatively connected to the aircraft input device 214 to determine the state of the control surface 338 and whether the control surface sets the aircraft 100 to the target attitude.

In this example, the attitude control system 102 may include a control device 334, such as a digital or analog limit switch, that increases a thruster 232 output past the control surface 338 responsive to the control surface 338 being within the threshold range of the limit. In general, a limit switch may open or close an electrical circuit when a particular limit is reached. In this example, the limit switch may be coupled to the thruster 232, and more specifically a motor or engine of the thruster 232, such that when the sensor 216 detects a particular state (i.e., that the control surface 338 is within a threshold range of a deflection limit or that the difference between the target attitude for the aircraft 100 and a measured attitude for the aircraft 100 is greater than a predetermined amount), the limit switch transmits an electrical signal to the motor or engine to increase the thruster 232 output.

As in the previous examples, the control device 334 (e.g., the limit switch) may increase the thruster 232 output based on the proximity of the control surface 338 to the limit and may incrementally increase the thruster 232 output as the control surface 338 approaches the limit.

In this example, there may be some cases when it is desirable to deactivate the thrust augmentation. For example, when the aircraft 100 is executing ground operations. In this example, the attitude control system 102 includes a deactivation system 336 to disengage the control device 334. Specifically, the deactivation system 336 may disengage the control device 334 responsive to the aircraft 100 being on a ground surface. That is, the deactivation system 336 may prevent the control device 334 (e.g., the limit switch) from transmitting the thrust-enhancing control signal to the throttle when the aircraft 100 is on the ground or in other circumstances where throttle augmentation is undesirable. In an example, the deactivation system 336 is a pilot-activated switch. In other examples, the deactivation system 336 includes a deactivation sensor such as an airspeed sensor, an altimeter, or a sensor that indicates the wheels of the aircraft 100 are bearing the weight of the aircraft 100, such as a pressure sensor. In an example, the deactivation system 336 may be a switch that either provides or cuts off power to the control device 334 (e.g., the limit switch).

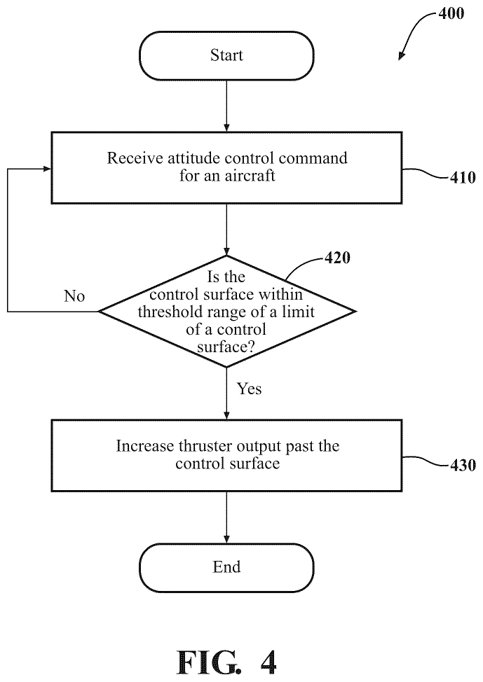

Additional aspects of augmenting control surface aerodynamic control will be discussed in relation to FIG. 4. Method 400 will be discussed from the perspective of the attitude control system 102 of FIGS. 2 and 3. While method 400 is discussed in combination with the attitude control system 102, it should be appreciated that the method 400 is not limited to being implemented within the attitude control system 102 but is instead one example of a system that may implement the method 400.

At 410, the detection module 228 receives an attitude control command for the aircraft 100. As described above, the aircraft 100 has a thruster-blown control surface 338, such as ailerons 110-1 and 110-2 behind propellers 108-1 and 108-2 as depicted in FIG. 1 above. The attitude control command may define a target attitude for the aircraft 100. That is, to effect a given command issued by a pilot, the attitude (e.g., roll, pitch, and yaw) of the aircraft 100 may be altered. The specific pose of the aircraft 100 while executing a commanded maneuver may be referred to as the target attitude of the aircraft 100. As described above, the attitude control command may be received by one or more aircraft input devices 214 such as control yokes, control sticks, buttons, dials, switches, remote control joysticks, etc.

In any case, at 420, the attitude control system 102 detects, responsive to the attitude control command, that a control surface 338 of the aircraft 100 is within a threshold range of a limit of the control surface 338 to set the aircraft 100 in the target attitude. That is, to achieve the target attitude and execute a particular maneuver, the control surfaces 338 may be deflected to different angular positions. However, it may be the case that the control surface 338 cannot set the aircraft 100 to the target attitude associated with an input command. This may be due to the control surface 338 being at or near a deflection limit where no greater deflection can be implemented to achieve increased aerodynamic control, or flight conditions where the control surface can otherwise not provide the target aerodynamic control. Both of these conditions are described above in greater detail. In some examples, this determination is based on sensor data 220. Accordingly, at 420, the detection module 228 controls the sensors 216 to acquire the sensor data 220. In one embodiment, the detection module 228 controls deflection sensors to determine when a control surface 338 is at or near its deflection limit. In another embodiment, the detection module 228 controls attitude sensors to determine when a measured attitude of the aircraft 100 is a predetermined amount different than a target attitude. In another embodiment, the detection module 228 controls an angle of attack sensor to determine when the aircraft is at or approaching an aerodynamic stall state.

In an embodiment, the detection module 228 controls the sensors 216 to acquire the sensor data 220 at successive iterations or time steps. Thus, the attitude control system 102, in one embodiment, iteratively executes the functions discussed at blocks 410-430 to acquire the sensor data 220 and provide information therefrom. Furthermore, the detection module 228, in one embodiment, executes one or more of the noted functions in parallel for separate observations to maintain updated perceptions.

If the control surface 338 is not within a threshold range of a limit (block 420, determination NO), no action is taken, and the detection module 228 continues to monitor sensor data 220. In this example, the thruster 232 is not always increased to augment control, but is done so to prevent a loss of attitude control. This may be beneficial as increasing the thruster output may cause the aircraft 100 to climb or accelerate, which may not be desirable. However, it may be desirable when the alternative is losing attitude control.

If the control surface 338 is within a threshold range of a limit (block 420, determination YES), at 430 the thruster output module 230 increases a thruster 232 output past the control surface 338. As described above, doing so increases the air velocity and pressure across the control surface 338, thus increasing its capability to generate aircraft-moving aerodynamic forces. Increasing the thruster 232 output may include transmitting an electrical signal to a motor or engine of the thruster 232 to increase the output to the thrust components.

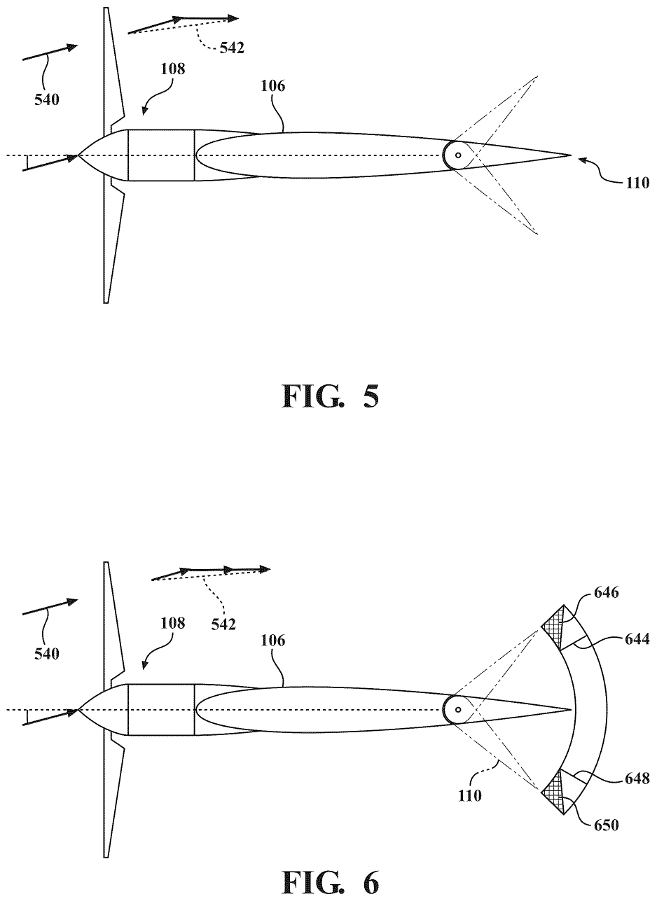

FIG. 5 is a cross-sectional view of a wing 106 and control surface 338 with unchanged thruster output past the control surface 338, according to an embodiment of the principles described herein. Specifically, FIG. 5 depicts an aileron 110 disposed on a wing 106 with a propeller 108 thrust source mounted to the front of the wing 106. As described above, it may be that freestream airflow 540 into the propeller 108 has a certain angle of attack as depicted in FIG. 5. The propeller 108, as with other thrusters, increases the velocity and pressure of the freestream airflow 540 resulting in a thrust air (e.g., freestream air added with propeller wash) having a second angle of attack 542. Specifically, the second angle of attack 542 of airflow behind the propeller 108 is a vector summation of the freestream airflow 540 and the propeller-induced airflow. As described above, the control surface (e.g., aileron 110) sits in the wake of the propeller 108 and imparts aerodynamic forces on the aircraft 100 as the thrust air passes over the control surface 338. Deflecting the control surface 338 (e.g., the aileron 110) to different positions as depicted in FIG. 5 results in changes of the attitude of the aircraft 100.

FIG. 6 is a cross-sectional view of a wing 106 and control surface (e.g., aileron 110), where thruster output is increased to achieve a target attitude, according to an embodiment of the principles described herein. Increasing thruster output may reduce the likelihood of a wing stall, thereby increasing the efficiency of a control surface 338. As described above, the thrust air has an angle of attack 542 that is a vector summation of the freestream airflow 540 and the propeller wash. Increasing the thruster output increases the velocity of the propeller wash, thus reducing the second angle of attack 542 over the wing 106, which increases the effectiveness of the control surface aerodynamic control.

FIG. 6 also depicts the thrust output ramping described above. Specifically, as described above, flight may be jarring, jerky, or otherwise uncontrolled and/or uncomfortable were the thrust increase to be fully applied once the control surface 338 (e.g., the aileron 110) reaches its deflection limit. Accordingly, as depicted in FIG. 6, there may be deflection points (indicated by the lines 644 and 648) that are before the deflection limits of the control surface 338 (e.g., the aileron 110). At this point, the thrust increase may be smoothly ramped from an initial level (i.e., 0%) to a maximum level where thrust increase is implemented at a maximum degree (i.e., 100%), whatever that value may be. The maximum level of thrust increase may correspond to the deflection limits of the control surface 338 (e.g., the aileron 110). While FIG. 6 depicts a linear ramp as depicted by the lines 646 and 650, the ramping or smoothing of the thrust increase may follow any other form, such as a quadratic ramping, etc. In this example, the thruster increase is 0% when the control surface (e.g., aileron 110) deflection is between the lines 644 and 648. Accordingly, thruster 232 output is not modulated when the control surface 338 is not within a threshold range of the deflection limits as depicted in FIG. 4 above.

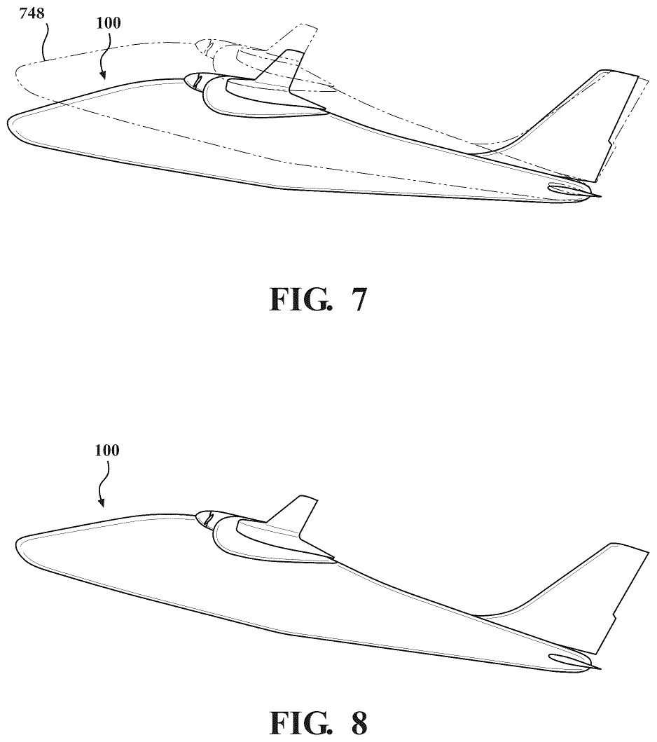

FIG. 7 is a side view of an aircraft 100 indicating a difference between a target attitude 748 and a measured attitude, according to an embodiment of the principles described herein. As described above, it may be the case that the pilot issues an attitude control command to change the attitude of the aircraft 100. In the example depicted in FIG. 7, the attitude control command may be a command to pitch the aircraft 100 upward. This attitude control command may define a target attitude 748 as indicated in the dashed outline of the aircraft 100 and a deflection position for the control surfaces 338. However, for a variety of reasons, it may be the case that the control surfaces 338 are unable to place the aircraft 100 in the target attitude 748. For example, as depicted in FIG. 7, the measured attitude of the aircraft 100, as depicted in a solid line, may be less than the target attitude 748. Accordingly, as described above, the attitude control system 102 may increase the thrust of the propellers to augment the airflow and aerodynamic control of the control surfaces 338. Responsive to the increase in thrust, the control surfaces 338 may exert greater aerodynamic force on the aircraft 100, such that the measured attitude of the aircraft 100 may match the target attitude 748 as depicted in FIG. 8.

FIG. 9 depicts a control loop 950 where thrust output increase is mapped to a deflection position of a control surface 338, according to an embodiment of the principles described herein. Specifically, FIG. 9 depicts a control loop 950 where the lookup table 222 maps the thrust output increase to a position of the control surface 338.

As described above, a pilot may input an attitude control command via an aircraft input device 214, which defines a target attitude for the aircraft 100. In an example, the target attitude may be converted into a surface command, which is a command signal for the various control surface system components to operate in a way to place the control surface 338 at a position to set the aircraft in the target attitude.

That is, to effect the attitude control, a control surface system actuates a variety of actuators, servos, potentiometers, etc., to physically move the control surface 338. As described above, the aircraft 100 may include sensors 216 that sense the actual, or measured, attitude state of the aircraft 100. In this example, the detection module 228 sums (e.g., “Σ”) the measured attitude and the target attitude from the attitude control command. The summation indicates a difference between the measured attitude and the target attitude. In some examples, the summation may be subjected to processing, filtering, time-based integration, time-based derivation, or other conditioning (e.g., “gain”) to enhance the summation signal.

In the example depicted in FIG. 9, the summation is converted into a control surface command, which may be a command to set the deflection of a control surface 338 to align the measured attitude with the target attitude from the attitude control command. In this example, the lookup table 222 may map the surface command (i.e., the desired angle for the control surface 338) to a thrust output increase. In this example, the threshold range at which the thrust output is increased may be mapped to a particular target angle for the control surface 338. For example, it may be that the deflection limit for a control surface 338 is 45°, as depicted by the end of the arched shape in FIG. 6. Accordingly, the lookup table 222 may include a mapping that provides a non-zero thrust increase value when the control surface is within some threshold range of the deflection limit, for example, 30°, as depicted by line 644 in FIG. 6. In this example, no thrust increase may be indicated for any control surface angle less than 30°. As such, the control loop 950 provides thrust augmentation just when the control surface 338 is within a threshold range of its deflection limit. As described above, the thrust increase value at this initiation point (e.g., 30° in the present example) may be small and increase as the surface command increases past the initiation point.

As described above, it may be the case that the thrust increase indication augments, or sums with, a throttle command. Thus, the overall thrust output for the thruster of the aircraft 100 is 1) the thrust output associated with a pilot throttle command and 2) the increased thrust amount to enhance the aerodynamic control of the control surface 338.

FIG. 10 depicts a control loop 1052 where thrust output increase is mapped to a difference between a measured attitude and a target attitude, according to an embodiment of the principles described herein.

As described above, a pilot may input an attitude control command via an aircraft input device 214, which defines a target attitude for the aircraft 100. In an example, the target attitude may be converted into a surface command, which is a command signal for the various control surface system components to operate in a way to place the control surface 338 at a position to set the aircraft in the target attitude.

As in the above example, the detection module 228 sums (e.g., “Σ”) the measured attitude and the target attitude from the attitude control command, with the summation indicating a difference between the measured attitude and the target attitude.

In the example depicted in FIG. 10, the summation representing the difference is transmitted to the thruster output module 230. In this example, the summation may still be converted into a control surface command, which may be a command to set the deflection of a control surface 338 to align the measured attitude with the target attitude from the attitude control command.

In this example, the threshold range at which the thrust output is increased may be mapped to a particular target difference between the measured and target attitudes. For example, it may be that a difference of 5% represents that the control surface 338 is within a threshold range of the limit of the control surface 338 to set the aircraft to the target attitude, with a greater percentage difference indicating that the control surface 338 cannot provide the target attitude, and a lesser percentage differencing indicating that the control surface 338 has adequately provided the target attitude.

Accordingly, the lookup table 222 may include a mapping that provides a non-zero thrust increase value when the difference between measured and target attitudes is greater than 5%, or any other threshold difference value. As described above, the thrust increase value at this initiation point (e.g., 5% in the present example) may be small, and may increase as the difference increases past the initiation point.

As described above, it may be the case that the thrust increase indication augments, or sums with, a throttle command. Thus, the overall thrust output for the thruster of the aircraft 100 is 1) the thrust output associated with a pilot throttle command and 2) the increased thrust amount to enhance the aerodynamic control of the control surface 338.

FIG. 11 depicts a control loop 1154 where thrust output increase is mapped to a time-dependent difference between a measured attitude and a target attitude as defined by an attitude control command, according to an embodiment of the principles described herein.

In the example depicted in FIG. 11, the control loop 1154 prescribes a smoothing function. For example, the difference between a measured attitude and the target attitude may be attributable to the control surface system complying with the attitude control command. Accordingly, rather than adjusting the thrust when the difference is greater than a predetermined amount, which may result in superfluous adjustments and/or jerky flight control, the thruster output module 230 may adjust the thrust when the difference is greater than a predetermined amount for a predetermined time. That is, the detection module 228 may include instructions that cause the processor 224 to detect a time-dependent difference between the target attitude and the measured attitude.

As in the above example, the detection module 228 sums (e.g., “Σ”) the measured attitude and the target attitude from the attitude control command, with the summation indicating a difference between the measured attitude and the target attitude. In the example depicted in FIG. 11, the time-dependent difference is calculated by integrating (e.g., “∫”) the summation of the difference between the measured attitude and the target attitude as indicated in the attitude control command.

Also in the example depicted in FIG. 11, the time-dependent summation representing the difference (e.g., the integration) is transmitted to the thruster output module 230. In this example, the real time difference and the time-dependent difference, may each be subject to processing, filtering, and/or conditioning before being summed and converted into a surface command, which may be a command to set the deflection of a control surface 338 to align the measured attitude with the target attitude from the attitude control command.

In this example, the threshold range at which the thrust output is increased may be mapped to a target time-dependent difference between the measured attitude and the target attitude. For example, it may be that a difference of 5% over a specific period of time represents that the control surface 338 is within a threshold range of the limit of the control surface 338 to achieve the target attitude, with a greater percentage over time indicating that the control surface 338 cannot provide the target attitude, and a lesser percentage over time indicating that the control surface 338 has adequately provided the target attitude.

Accordingly, the lookup table 222 may include a mapping that provides a non-zero thrust increase value when the difference between measured and target attitudes is greater than 5% over a period of time. As described above, the thrust increase value at this initiation point (e.g., 5% in the present example) may be small and increase as the difference increases past the initiation point. While FIGS. 10 and 11 describe a particular difference threshold, any other threshold difference may trigger an increased thrust to augment control surface capability.

Note that while FIG. 11 depicts integration as one mechanism for generating a time-dependent difference, other smoothing mechanisms may be employed, such as ramps, filters, IIR filters, delays, etc. In any case, as described above, the control surface enhancing thrust may augment, or sum with, a pilot throttle command. Thus, the overall thrust output for the thruster of the aircraft 100 is 1) the thrust output associated with a pilot throttle command and 2) the increased thrust amount to enhance the aerodynamic control of the control surface 338.

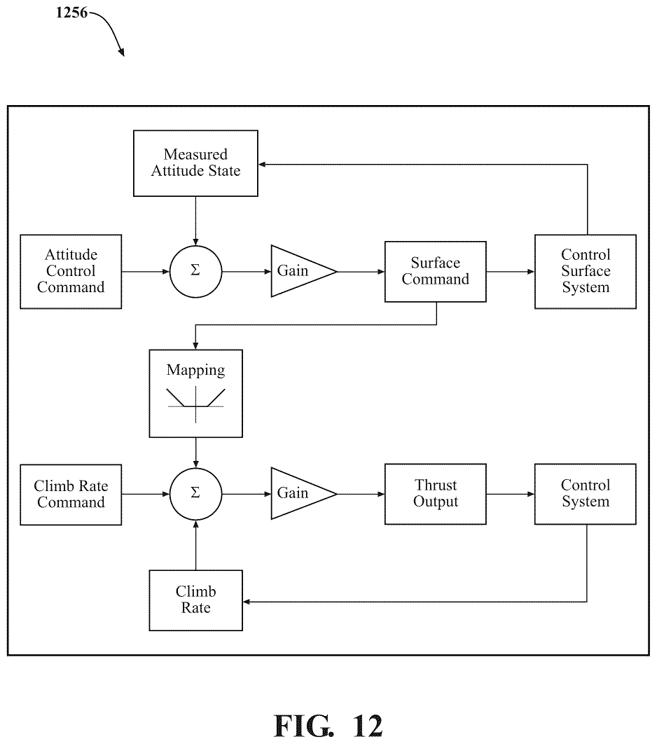

FIG. 12 depicts a control loop 1256 where thrust output augments a climb rate command, according to an embodiment of the principles described herein. Specifically, FIG. 12 depicts a control loop 1256 where the lookup table 222 maps a climb rate increase to a position of the control surface 338 as described above in connection with FIG. 9.

In the example depicted in FIG. 12, the climb rate increase indication augments, or sums with, a climb rate command. In the example depicted in FIG. 9, the thrust increase augmented a pilot's open-loop command of the thrust, i.e., a command to increase thrust. In the example depicted in FIG. 12, the climb rate command is a closed-loop command. That is, the pilot, rather than directly indicating a thrust amount, indicates a climb amount, and a control system calculates and selects a thrust output to execute the climb maneuver. Accordingly, in this control loop 1256, the climb rate command is compared against the actual climb rate of the aircraft 100, with a summation being processed, filtered, and/or conditioned to alter the thrust output to achieve the desired climb rate.

In this example, the climb rate increase indication augments, or sums with, a pilot-issued climb rate command. The increased climb rate causes the overall thrust output to increase relative to the pilot-issued climb rate command, thereby enhancing the aerodynamic control of the control surface 338.

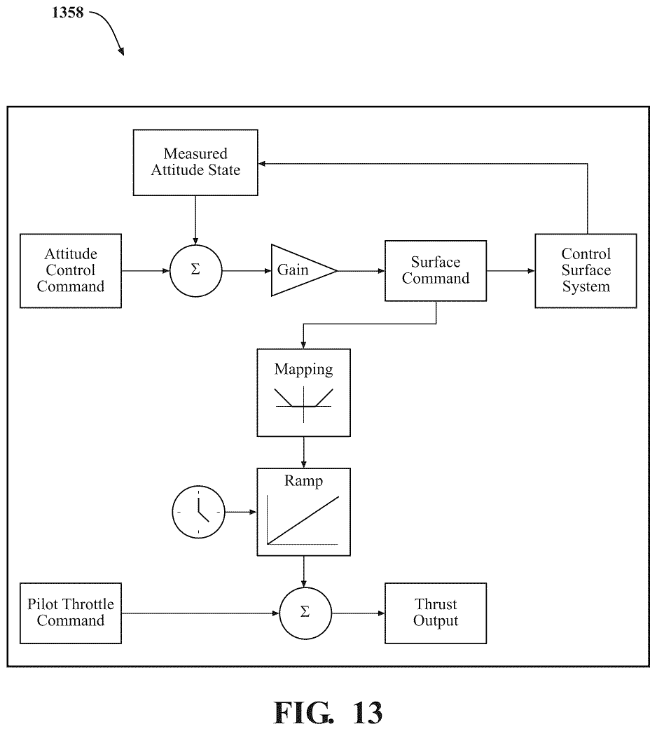

FIG. 13 depicts a control loop 1358 where thrust output is smoothed via time-dependence on previous thrust output increases. As in the example depicted in FIG. 9, in the control loop 1358 of FIG. 13, the thrust output increase is mapped to a deflection position of a control surface 338, where the lookup table 222 maps the thrust output increase to a position of the control surface 338.

As described above, a pilot may input an attitude control command via an aircraft input device 214, which defines a target attitude for the aircraft 100. In an example, the target attitude may be converted into a surface command, which is a command signal for the various control surface system components to operate in a way to place the control surface 338 at a position to set the aircraft in the target attitude. Also as in the above example, the detection module 228 sums (e.g., “Σ”) the measured attitude and the target attitude from the attitude control command, with the summation indicating a difference between the measured attitude and the target attitude. In some examples, the summation may be subjected to processing, filtering, time-based integration, time-based derivation, or other conditioning (e.g., “gain”) to enhance the summation signal.

However, in the example depicted in FIG. 13, the control loop 1358 prescribes a smoothing function. That is, the mapping may account for ramping up the thrust output. That is, the amount of thrust increase may increase over time. Doing so results in a smooth increase in thrust output for a smoother ride/flight of the aircraft 100. For example, the thrust output increase may be incrementally increased over time, starting from a nominal value, such as zero, to a maximum value, which maximum value may be the thrust output increased value that maps to the control surface 338 deflection position. Accordingly, rather than adjusting the thrust when the difference is greater than a predetermined amount, which may result in superfluous adjustments and/or jerky flight control, the thruster output module 230 may adjust the thrust gradually over time.

As described above, it may be the case that the thrust increase indication augments, or sums with, a throttle command. Thus, the overall thrust output for the thruster of the aircraft 100 is 1) the thrust output associated with a pilot throttle command and 2) the increased thrust amount to enhance the aerodynamic control of the control surface 338.

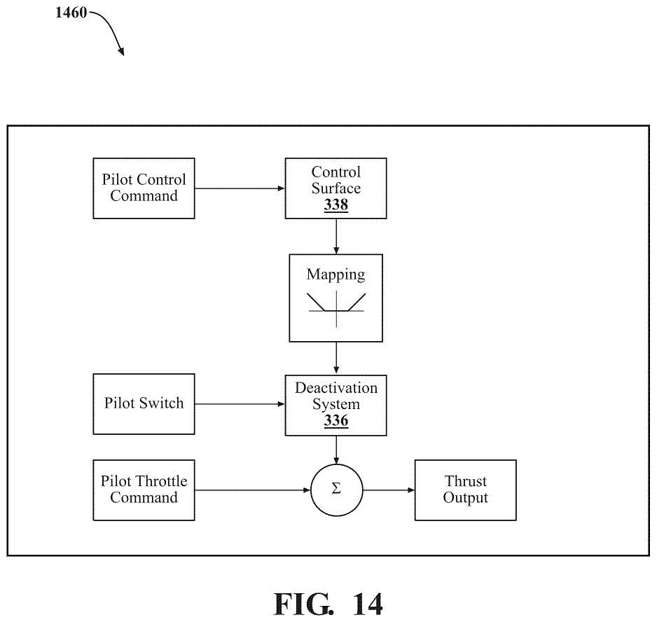

FIG. 14 depicts a control loop 1460 operated in an open-loop system such as that depicted in FIG. 3. In this example, a pilot may issue a control command, for example, via an aircraft input device 214. Via mechanical or electrical systems, a control surface control system may alter the position of the control surface 338. Sensors coupled to the control surfaces 338, such as those sensors 216 depicted in FIG. 3 may determine the position of the control surface 338. Accordingly, as described above, the attitude control system 102 may alter the throttle output based on the position of the control surface 338 and its inability to set the aircraft 100 to a target attitude as defined by the pilot control command (e.g., the position of a control stick) of the aircraft input device 214.

Moreover, as described above, the attitude control system 102 may include a deactivation system 336, which may deactivate the thrust output increases in certain circumstances, for example, when the aircraft 100 is on the ground surface.

As described above, it may be the case that the thrust increase indication augments, or sums with, a throttle command. Thus, the overall thrust output for the thruster of the aircraft 100 is 1) the thrust output associated with a pilot throttle command and 2) the increased thrust amount to enhance the aerodynamic control of the control surface 338.

Note that while FIGS. 9-14 depict specific examples of control loops, a variety of different control structures may be implemented in accordance with the principles described herein.

As such, the present attitude control system 102 enhances the aerodynamic control of an aircraft by its control surfaces 338 by increasing thruster output responsive to an indication that the control surface 338 is within a threshold range of a limit of the control surface to provide the desired attitude state for the aircraft.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-14, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. The systems, components, and/or processes also can be embedded in a machine-readable storage, such as a computer program product or other data program storage device, readable by a machine, tangibly embodying a program of instructions executable by the machine to perform methods and processes described herein. These elements also can be embedded in an application product which comprises the features enabling the implementation of the methods described herein, and which, when loaded in a processing system, is able to carry out these methods.

Furthermore, arrangements described herein may take the form of a computer program product embodied in one or more machine-readable media having machine-readable program code embodied, e.g., stored, thereon. Any combination of one or more machine-readable media may be utilized. The phrase “machine-readable storage medium” means a non-transitory storage medium. A machine-readable storage medium may be, for example, but not limited to, an electronic, magnetic, optical, electromagnetic, infrared, or semiconductor system, apparatus, or device, or any suitable combination of the foregoing. A non-exhaustive list of the machine-readable storage medium can include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or a combination of the foregoing. In the context of this document, a machine-readable storage medium is, for example, a tangible medium that stores a program for use by or in connection with an instruction execution system, apparatus, or device.

Program code embodied on a machine-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory storing machine-readable instructions that, when executed by the processor, cause the processor to:
receive an attitude control command for an aircraft that has a thruster-blown control surface, the attitude control command defines a target attitude for the aircraft;
detect, responsive to the attitude control command, that a control surface of the aircraft is within a threshold range of a limit of the control surface to set the aircraft to the target attitude; and
increase a thruster output past the control surface responsive to the control surface being within the threshold range of the limit.

2. The system of claim 1, wherein the machine-readable instruction that causes the processor to detect that the control surface is within the threshold range of the limit comprises machine-readable instructions that, when executed by the processor, cause the processor to:
detect a difference between the target attitude for the aircraft and a measured attitude of the aircraft; and
determine that the difference exceeds a predetermined amount.

3. The system of claim 2, wherein the machine-readable instruction that causes the processor to detect the difference between the target attitude and the measured attitude comprises a machine-readable instruction that causes the processor to detect a time-dependent difference between the target attitude and the measured attitude.

4. The system of claim 1, wherein the machine-readable instruction that causes the processor to detect that the control surface is within the threshold range of the limit comprises machine-readable instructions that, when executed by the processor, cause the processor to detect that the control surface is within a threshold range of a deflection limit for the control surface.

5. The system of claim 1, wherein the machine-readable instruction that causes the processor to detect that the control surface is within the threshold range of the limit comprises a machine-readable instruction that, when executed by the processor, causes the processor to detect that the control surface is in an aerodynamic stall state.

6. The system of claim 1, wherein:
the machine-readable instruction that causes the processor to increase the thruster output past the control surface comprises a machine-readable instruction that, when executed by the processor, causes the processor to increase the thruster output based on a proximity of the control surface to the limit; and
a closer proximity of the control surface to the limit triggers a greater increase in the thruster output.

7. The system of claim 6, wherein the memory further comprises a machine-readable instruction that, when executed by the processor, causes the processor to incrementally increase the thruster output as the control surface approaches the limit.

8. The system of claim 1, further comprising a lookup table that maps thrust output increase to at least one of:
a deflection of the control surface;
a difference between a control input in the attitude control command and a measured attitude of the aircraft;
a time-dependent difference between the control input in the attitude control command and the measured attitude of the aircraft; or
a time-dependence on a previous thrust output increase.

9. The system of claim 1, wherein the machine-readable instruction that causes the processor to increase the thruster output past the control surface comprises a machine-readable instruction that, when executed by the processor, cause the processor to increase the thruster output to augment at least one of a thrust command, a climb rate command, or a total energy state command.

10. A system, comprising:
an aircraft input device, the aircraft input device receives an attitude control command for an aircraft that has a thruster-blown control surface, the attitude control command defines a target attitude for the aircraft;
a sensor, the sensor detects, responsive to the attitude control command, that a control surface of the aircraft is within a threshold range of a limit of the control surface to set the aircraft to the target attitude; and
a control device, the control device increases a thruster output past the control surface responsive to the control surface being within the threshold range of the limit.

11. The system of claim 10, wherein, the sensor:
detects a difference between the target attitude for the aircraft and a measured attitude of the aircraft; and
determines that the difference exceeds a predetermined amount.

12. The system of claim 10, further comprising a deactivation system, the deactivation system disengages the control device.

13. The system of claim 12, wherein the deactivation system:
disengages the control device responsive to the aircraft being on a ground surface; and
further comprises a deactivation sensor to detect when the aircraft is on the ground surface.

14. The system of claim 10, wherein the sensor detects that the control surface is within a threshold range of a deflection limit for the control surface.

15. The system of claim 10, wherein the control device:
increases the thruster output based on a proximity of the control surface to the limit; and
incrementally increases the thruster output as the control surface approaches the limit.

16. A method, comprising:
receiving an attitude control command for an aircraft that has a thruster-blown control surface, the attitude control command defines a target attitude for the aircraft;
detecting, responsive to the attitude control command, that a control surface of the aircraft is within a threshold range of a limit of the control surface to set the aircraft to the target attitude;
and increasing a thruster output past the control surface responsive to the control surface being within the threshold range of the limit.

17. The method of claim 16, wherein detecting that the control surface is within the threshold range of the limit comprises:
detecting a difference between the target attitude for the aircraft and a measured attitude of the aircraft; and
determining that the difference is greater than a predetermined amount.

18. The method of claim 17, wherein detecting the difference between the target attitude and the measured attitude comprises detecting a time-dependent difference between the target attitude and the measured attitude.

19. The method of claim 17, detecting that the control surface is within the threshold range of the limit comprises detecting that the control surface is within a threshold range of a deflection limit for the control surface.

20. The method of claim 16, wherein:
increasing the thruster output past the control surface comprises increasing the thruster output based on a proximity of the control surface to the limit; and
the method further comprises incrementally increasing the thruster output as the control surface approaches the limit.
